(19) United States
(12) Patent Application Publication
(10) Pub. No.: US 2026/0358209 A1
(43) Pub. Date: Nov. 12, 2026

(54) Microscopic Object Collection Method and Collection System

(71) Applicant: University Public Corporation Osaka, Osaka (JP)

(72) Inventors: Shiho Tokonami, Sakai-shi, Osaka (JP); Takuya Iida, Sakai-shi, Osaka (JP)

(21) Appl. No.: 19/515,664

(22) PCT Filed: Sep. 3, 2024
(86) PCT No.: PCT/JP2024/031559

§ 371 Date: Mar. 2, 2026

(30) Foreign Application Priority Data
Sep. 4, 2023 (JP) 2023-142762

(51) Int. Cl. G01N 1/40; B01J 19/12; G01N 1/44

(52) U.S. Cl. CPC G01N 1/40; B01J 19/12; G01N 1/44

(57) ABSTRACT

In a microscopic object collection method, a plurality of microscopic objects contained in a sample are collected. The microscopic object collection method includes first to third steps. The first step is preparing a collection substrate including a plurality of pores each having a partition wall that separates adjacent openings. The second step is introducing the sample onto the collection substrate. The third step is irradiating the plurality of pores with a laser beam focused by a lens. The irradiating includes scanning the plurality of pores with a beam waist of the laser beam.

### TECHNICAL FIELD

The present disclosure relates to a microscopic object collection method and a collection system, and more particularly to a technique for collecting a plurality of microscopic objects contained in a liquid sample.

### BACKGROUND

A device for collecting microorganisms, disclosed in WO2017/195872, collects a plurality of microorganisms dispersed in a liquid sample. The collecting device includes a light source and a holding member configured to be capable of holding a liquid sample. A photothermal conversion region is formed in the holding member. The photothermal conversion region converts light from the light source into heat to heat the liquid sample, thereby producing a heat convection in the liquid sample.

A method for detecting an analyte, disclosed in WO2021/040021, includes first to third steps. The first step is distributing a liquid sample containing a plurality of fine particles, each of which is modified with a host molecule to be specifically bound to the analyte, in a microchannel using a pump. The second step is irradiating the liquid sample with non-resonant light that is light outside a wavelength range of electronic resonance of the plurality of fine particles. The third step is detecting the analyte based on a signal from an optical receiver that receives light from the liquid sample.

### SUMMARY OF DISCLOSURE

There is a need for a technique for rapidly collecting a plurality of microscopic objects contained in a liquid sample, that is, a technique for reducing the time required to collect a plurality of microscopic objects contained in a liquid sample.

One object of the present disclosure, which has been made to solve problems above, is to reduce the time required to collect a plurality of microscopic objects contained in a liquid sample.

In a microscopic object collection method according to an aspect of the present disclosure, a plurality of microscopic objects contained in a liquid sample are collected. The microscopic object collection method includes first to third steps. The first step is preparing a substrate including a plurality of pores each having a partition wall that separates adjacent ones of openings. The second step is introducing the liquid sample onto the substrate. The third step is irradiating the plurality of pores with a laser beam focused by a lens. The irradiating includes scanning the plurality of pores with a beam waist of the laser beam.

In a microscopic object collection method according to another aspect of the present disclosure, a plurality of microscopic objects contained in a liquid sample are collected. The microscopic object collection method includes first to third steps. The first step is preparing a substrate including a plurality of pores each having a partition wall that separates adjacent ones of openings. The second step is introducing the liquid sample onto the substrate. The third step is irradiating the plurality of pores with a laser beam without being focused by a lens. The irradiating includes scanning the plurality of pores with the laser beam.

A microscopic object collection system according to still another aspect of the present disclosure collects a plurality of microscopic objects contained in a liquid sample. The microscopic object collection system includes a holder configured to hold a substrate including a plurality of pores each having a partition wall that separates adjacent ones of openings, a light source configured to emit a laser beam, a lens configured to focus the laser beam to generate a beam waist, a driver configured to change a position of the beam waist relative to the plurality of pores, and a controller configured to control the driver such that the plurality of pores are scanned with the beam waist.

According to the present disclosure, the time required to collect a plurality of microscopic objects contained in a liquid sample can be reduced.

### BRIEF DESCRIPTION OF DRAWINGS

FIG. 1 is a block diagram showing an example of an overall configuration of a microscopic object collection system according to an embodiment of the present disclosure.

FIG. 2 is a perspective view showing an example of a configuration of a collection kit.

FIG. 3 is a top view and a cross-sectional view of the collection kit.

FIG. 4 is a perspective view showing an example of a configuration of a collection substrate.

FIG. 5 is a view showing an optical observation image of a collection substrate actually produced.

FIG. 6 is a conceptual diagram for describing light-induced force generated by a laser beam.

FIG. 7 is a conceptual diagram for describing a density distribution of microorganisms around the laser beam.

FIG. 8 is a conceptual diagram for describing how microorganisms are collected in association with scanning of the collection kit with a laser beam.

FIG. 9 is a flowchart showing an example of a procedure of processing of collecting microorganisms.

FIG. 10 shows SYTO9 images showing a collection result of bacteria in Comparative Example 1.

FIG. 11 is a diagram showing light irradiation time dependency of the result of collection of bacteria in Comparative Example 1.

FIG. 12 is a view showing a first example of a collection result of Lactobacillus casei in Example 1.

FIG. 13 is a view showing a second example of the collection result of Lactobacillus caseiin Example 1.

FIG. 14 is a view showing an example of a collection result of Pseudomonas aeruginosa in Example 2.

FIG. 15 is a view showing a collection result of three types of bacteria in Comparative Example 2.

FIG. 16 is a view showing a collection result of three types of bacteria in Example 3.

FIG. 17 is a diagram showing an example of a configuration of a collection kit for selectively collecting microscopic objects.

FIG. 18 is a view showing a collection result of fluorescent beads in a case in which an objective lens is not used.

### DETAILED DESCRIPTION

### Description of Terms

In the present disclosure and embodiments thereof, a “nanometer order” means a range from 1 nm to 1000 nm (=1 μm). A “micrometer order” means a range from 1 μm to 1000 μm (=1 mm). Therefore, a “range from the nanometer order to the micrometer order” means a range from 1 nm to 1000 μm. The “range from the nanometer order to the micrometer order” may typically indicate a range from several nanometers to several hundred micrometers, preferably a range from 100 nm to 100 μm, and more preferably a range from several hundred nanometers to several ten micrometers.

In the present disclosure and the embodiments thereof, the term “microscopic object” means an object having a size within the range from the nanometer order to the micrometer order. The microscopic object is not limited to a particular shape and has a spherical shape, a shape of an oval sphere, or a rod shape (a pole shape), for example. When the microscopic object has the shape of the oval sphere, at least one of the length along the major axis and the length along the minor axis of the oval sphere should only be within the range from the nanometer order to the micrometer order. When the microscopic object has the rod shape, at least one of the width and length of the rod should only be within the range from the nanometer order to the micrometer order.

Examples of the microscopic object include a metal nanoparticle, a metal nanoparticle assembly, a metal nanoparticle condensed structure body, a semiconductor nanoparticle, an organic nanoparticle, a resin bead, and a particulate matter (PM). The “metal nanoparticle” refers to a metal particle having a size on the nanometer order. The “metal nanoparticle assembly” refers to an assembly formed by aggregation of a plurality of metal nanoparticles. The “metal nanoparticle condensed structure body” refers, for example, to a structure in which a plurality of metal nanoparticles are fixed to a surface of a base material (such as a resin bead) with an interactive site being interposed and are arranged to be spaced from one another at intervals, the intervals being the diameter of the metal nanoparticle or less. The “semiconductor nanoparticle” refers to a semiconductor particle having a size on the nanometer order. The “organic nanoparticle” refers to a particle composed of an organic compound and having a size on the nanometer order. The “resin bead” refers to a particle composed of resin and having a size within the range from the nanometer order to the micrometer order. The “PM” refers to a particulate substance having a size on the micrometer order. Examples of the PM include PM2.5 and suspended particulate matter (SPM).

The microscopic object may be a biologically originated substance (a biological substance). More specifically, the microscopic object may include cells, microorganisms (such as bacteria and fungi), pharmaceuticals, biopolymers (such as proteins, nucleic acids, lipids, and polysaccharides), antigens (such as allergens), and viruses.

In the present disclosure and the embodiments thereof, a “second order” means a duration from one second to 60 seconds. A “single-digit second order” means a duration of one second or more and less than 10 seconds, and a “two-digit second order” means a duration of 10 seconds or more and less than 60 seconds. A “minute order” means a duration from one minute to 60 minutes. A “single-digit minute order” means a duration of one minute or more and less than 10 minutes, and a “two-digit minute order” means a duration of 10 minutes or more and less than 60 minutes.

In the present disclosure and the embodiments thereof, the term “light-induced force” is a generic term for “dissipative force”, “gradient force”, and “inter-object photo-induced force.” The “dissipative force” is force generated when momentum of light is provided for a substance in a dissipation process such as light scattering or light absorption. The “gradient force” is force that moves a substance to a stable point of an electromagnetic potential when the substance in which light-induced polarization occurs is placed in an uneven electromagnetic field. The “inter-object photo-induced force” is a sum of force due to a longitudinal electric field and force due to a transverse electric field (radiant field) generated from induced polarization in a plurality of substances having been optically excited.

Note that the dissipative force includes a component (hereinafter referred to as “absorption force”) due to absorption of light and a component (hereinafter referred to as “scattering force”) due to scattering of light. The absorption force is proportionate to an absorption cross-section of a target object and a laser intensity (=output/irradiation area). The scattering force is proportionate to a scattering cross-section of a target object and a laser intensity. When non-resonant light (which will be described later) is employed, the absorption force included in the dissipative force is negligibly small. Thus, the dissipative force may be translated into the scattering force.

In the present disclosure and the embodiments thereof, the “visible light” means light in a wavelength range of 400 nm to 700 nm. The “infrared light” means light in a wavelength range of 700 nm to 10,000 μm (=1 mm), preferably means light in a wavelength range of 700 nm to 2,500 nm, and more preferably means light in a wavelength range of 700 nm to 1,400 nm. The “white light” means incoherent light in which monochromatic light rays having a plurality of wavelengths belonging to a wavelength range (e.g., a wavelength range of 200 nm to 1100 nm) from an ultraviolet region to a near infrared region are overlapped on one another.

In the present disclosure and the embodiments thereof, the “resonance light” means light that causes large light-induced polarization in a microscopic object by incidence on the microscopic object. The light-induced polarization is electric polarization generated when electrons in the substance are excited by light. The resonance light has a wavelength within a wavelength range of electronic resonance of the microscopic object. On the other hand, the “non-resonant light” means light in which the light-induced polarization generated in a microscopic object by the incidence on the microscopic object is small. The non-resonant light has a wavelength outside the wavelength range of electronic resonance of the microscopic object.

In the present disclosure and the embodiments thereof, a “host substance” means a substance capable of being specifically bound (selectively adhering) to a microscopic object to be collected. Examples of the combination of the host substance and the microscopic object (a substance present on the surface of the microscopic object) include an antigen and an antibody, a sugar chain and a protein, a lipid and a protein, a low molecular weight compound (ligand) and a protein, a protein and a protein, and a single-stranded DNA and a single-stranded DNA. When one of the two having specific affinities is to be collected, the other can be used as the host substance.

### Embodiments

Hereinafter, embodiments of the present disclosure will be described in detail with reference to the drawings. In the drawings, the same or corresponding portion is denoted by the same reference numeral, and the description thereof will not be repeated.

An x-direction and a y-direction represent a horizontal direction. The x-direction and the y-direction are orthogonal to each other. A z-direction represents a vertical direction. The gravity is oriented below in the z-direction. An upper side in the z-direction (vertically upward) will be abbreviated as “above” or “upward”, and a lower side in the z-direction (vertically downward) will be abbreviated as “below” or “downward.”

In the present embodiment, an example in which a microscopic object to be collected is a microorganism will be described. As described above, however, the microscopic object may not be a biological substance, or may be a biological substance other than microorganisms.

### System Configuration

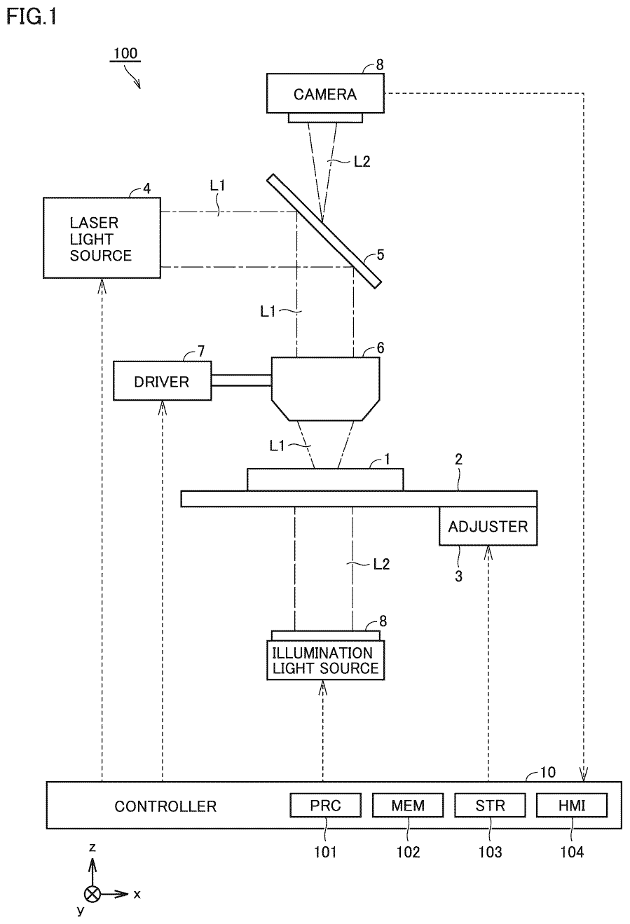

FIG. 1 is a block diagram showing an example of an overall configuration of a microscopic object collection system according to an embodiment of the present disclosure. A collection system 100 includes a collection kit 1, an XYZ-axis (triaxial) stage 2, an adjuster 3, a laser light source 4, a dichroic mirror 5, an objective lens 6, a driver 7, an illumination light source 8, a camera 9, and a controller 10.

Collection kit 1 holds a sample. The sample is a liquid sample containing microorganisms to be collected. The liquid (dispersion medium) is not limited to a particular type and is sterile water in this example. Note that collection kit 1 may not be an element constituting collection system 100.

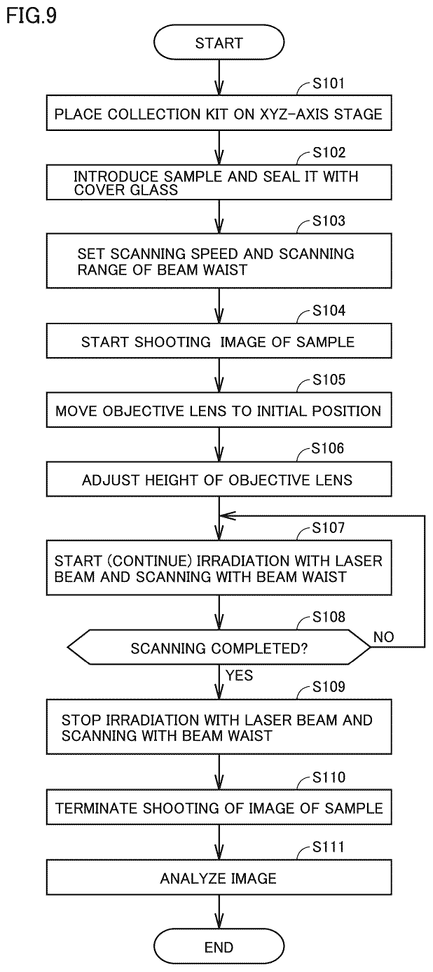

XYZ-axis stage 2 holds collection kit 1. XYZ-axis stage 2 includes a through-hole (not illustrated) that allows passage of white light (which will be described later). Although not illustrated, a plurality of collection kits may be prepared. In that case, plurality of collection kits 1 are sequentially placed on XYZ-axis stage 2, and collection processing (see FIG. 9) is performed for each of collection kits 1.

Adjuster 3 is a drive mechanism such as a servomotor and a focusing handle. Adjuster 3 adjusts a horizontal position and a vertical height of XYZ-axis stage 2 in response to a command from controller 10. Accordingly, the relative positional relationship between collection kit 1 and objective lens 6 can be adjusted.

Laser light source 4 emits a laser beam (denoted by L1) of a continuous wave (CW) having high coherence in response to a command from controller 10. Output (unit: W) of the laser beam can also be adjusted by a command from controller 10. It is desirable that the laser beam should be non-resonant light outside an optical absorption range of the microorganisms (outside the wavelength range of electronic resonance). This is for preventing the laser beam itself from damaging the microorganisms. The laser beam in the present embodiment has a wavelength (specifically, 1064 nm) in the near infrared region. The laser beam emitted from laser light source 4 is directed to dichroic mirror 5.

Dichroic mirror 5 is arranged between laser light source 4 and objective lens 6 and between objective lens 6 and camera 9. Dichroic mirror 5 is configured to reflect infrared light while passing visible light. Thus, the laser beam which is near infrared light is reflected by dichroic mirror 5 to be directed to objective lens 6.

Objective lens 6 focuses the laser beam reflected by dichroic mirror 5. Collection kit 1 is irradiated with the beam focused by objective lens 6. It is desirable to employ as objective lens 6 one that generates a beam waist which is smaller than an opening size φ (which will be described later) of pores provided in collection kit 1.

Driver 7 is an electric actuator and is, for example, a motor driver (such as a servomotor or a stepping motor) to be mechanically displaced in response to a command from controller 10. Driver 7 may be a piezoelectric element to be displaced in accordance with a voltage applied from controller 10. Driver 7 changes the horizontal and vertical positions of objective lens 6. By changing the horizontal position of objective lens 6 using driver 7, collection kit 1 can be irradiated with the laser beam at any position. In other words, collection kit 1 can be scanned with the laser beam. By changing the vertical position of objective lens 6 using driver 7, an irradiation range of the laser beam (a height of the beam waist which will be described later) in collection kit 1 can be adjusted. Note that adjustment of the horizontal position and adjustment of the vertical position of objective lens 6 may be achieved by different drivers.

Alternatively, objective lens 6 may be fixed in position, and collection kit 1 may be scanned with fixed objective lens 6 by adjuster 3. That is, adjuster 3 may function as a “driver” according to the present disclosure.

Illumination light source 8 is an artificial light source such as a halogen lamp, a mercury lamp, a light emitting diode (LED), or a fluorescent lamp. Illumination light source 8 emits white light (denoted by L2) for shooting an image of a sample on collection kit 1 in response to a command from controller 10. Collection kit 1 is irradiated with the white light which has traveled through the through-hole (not illustrated) provided in XYZ-axis stage 2 and which passes through collection kit 1. The white light passed through collection kit 1 is directed to dichroic mirror 5 by way of objective lens 6. The white light which is visible light passes through dichroic mirror 5 to be captured into camera 9.

Camera 9 includes an image sensor such as a charge coupled device (CCD) image sensor or a complementary metal oxide semiconductor (CMOS) image sensor. Camera 9 shoots an image of a sample on collection kit 1 in response to a command from controller 10 and outputs the shot image to controller 10. The image shot by camera 9 may be a still image or a moving image.

Controller 10 controls equipment (adjuster 3, laser light source 4, driver 7, illumination light source 8, and camera 9) in collection system 100. Controller 10 subjects the image shot by camera 9 to an image analysis (a fluorescence image analysis in examples which will be described later). Controller 10 includes a processor 101, a memory 102, a storage 103, and a human machine interface (HMI) 104.

Processor 101 is an arithmetic processing unit such as a central processing unit (CPU) or a micro processing unit (MPU). Memory 102 is a volatile storage device such as a dynamic random access memory (DRAM) or a static random access memory (SRAM). Storage 103 is a non-volatile storage device such as a hard disk drive (HDD), a solid state drive (SSD), or a flash memory. Storage 103 stores a program. The program includes a computer-readable instruction for controlling collection system 100. Processor 101 executes the program on memory 102 to achieve various types of processing.

HMI 104 includes input equipment (such as a switch, a mouse, a keyboard, and a touch panel) and receives a user's operation to output a signal indicating the user's operation to processor 101. HMI 104 also includes output equipment (such as a display) and displays information (such as an operation status, a measurement result, and an analytical result of collection system 100) managed by controller 10 to a user. Note that controller 10 may be divided into a plurality of devices for respective functions.

The system configuration of collection system 100 shown in FIG. 1 is an example. An optical system of collection system 100 may include other optical parts (such as a mirror, a half mirror, a beam splitter, a filter, and an optical fiber) instead of or in addition to dichroic mirror 5. The optical system shown in FIG. 1 is configured such that the sample is irradiated with white light from illumination light source 8 upward from below and such that camera 9 located above shoots an image of the sample located below. However, the optical system of collection system 100 may be configured such that the sample is irradiated with white light from illumination light source 8 upward from below and such that camera 9 located below shoots an image of the sample located above.

Driver 7 may be configured to move part of the optical system in addition to objective lens 6. Driver 7 may be configured to drive XYZ-axis stage 2 relative to objective lens 6 instead of driving objective lens 6 relative to XYZ-axis stage 2.

### Configuration of Kit

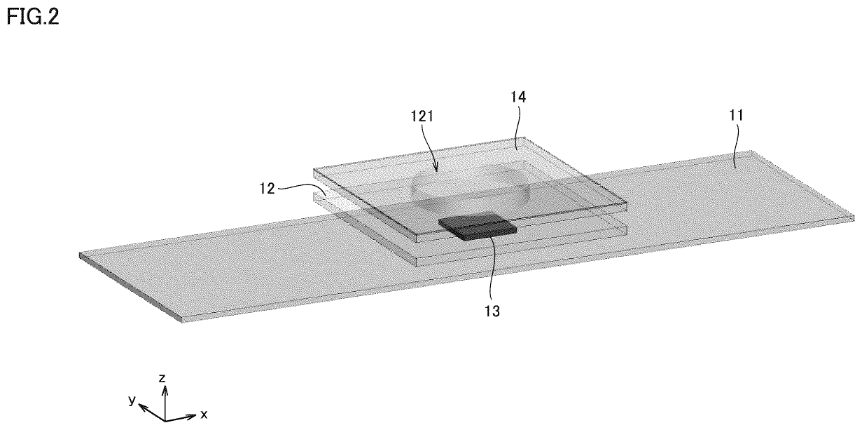

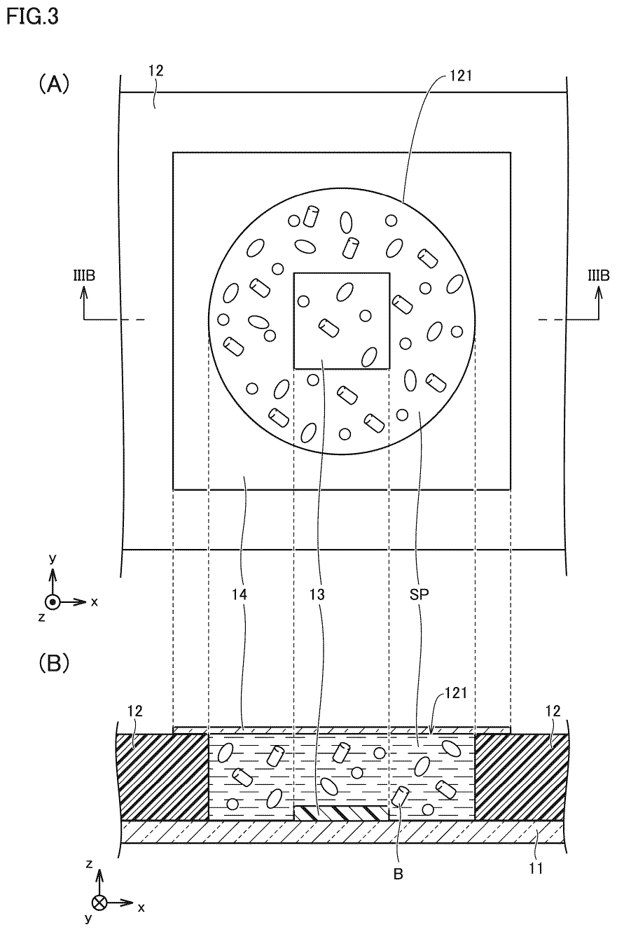

FIG. 2 is a perspective view showing an example of a configuration of collection kit 1. FIG. 3(A) is a top view of collection kit 1. FIG. 3(B) is a cross-sectional view of collection kit 1 taken along the line IIIB-IIIB in FIG. 3(A). With reference to FIG. 2 and FIG. 3, collection kit 1 includes a base material 11, a holding frame 12, a collection substrate 13, and a cover glass 14.

Base material 11 is provided to ensure a mechanical strength of collection kit 1. Furthermore, base material 11 is configured to pass white light from illumination light source 8. Specifically, base material 11 is a glass substrate (slide glass), for example. Base material 11 may be a silicone substrate, a resin (e.g., polyethylene terephthalate (PET)) film, or the like. Base material 11 is not limited to a particular shape and has a planar shape (rectangular parallelepiped shape) in this example. Base material 11 may be subjected to hydrophilic treatment (e.g., plasma treatment).

Holding frame 12 holds a sample (denoted by SP). Holding frame 12 is a double-sided tape, for example. The material of holding frame 12 may be resin (e.g., dimethylpolysiloxane (PDMS)). Holding frame 12 may include a columnar through-hole 121 in this example. Through-hole 121 functions as a “fluid reservoir” for accumulating a certain amount of the sample. Base material 11 and holding frame 12 may be formed integrally.

Collection substrate 13 is arranged inside through-hole 121 of holding frame 12. Collection substrate 13 is configured to collect microorganisms by irradiation with a laser beam. Note that collection substrate 13 corresponds to a “substrate” according to the present disclosure.

Collection substrate 13 (in particular, a region to be irradiated with a laser beam) preferably does not contain a photothermal conversion material (e.g., a metal thin film) that converts the laser beam into heat. This is for avoiding microorganisms undergoing thermal damage that would be caused by heat to be produced in the photothermal conversion material.

Cover glass 14 covers the sample held in through-hole 121 of holding frame 12 from above. As shown in FIG. 3(B), it is desirable that through-hole 121 should be filled with the sample and that the sample should be sealed with cover glass 14.

Note that a plurality of types (in this example, three types) of microorganisms (denoted by B) are schematically illustrated in the sample in FIG. 3(A) and FIG. 3(B). However, the types of the microorganisms are not limited to the three types, and may be a single type, two types, or four types or more.

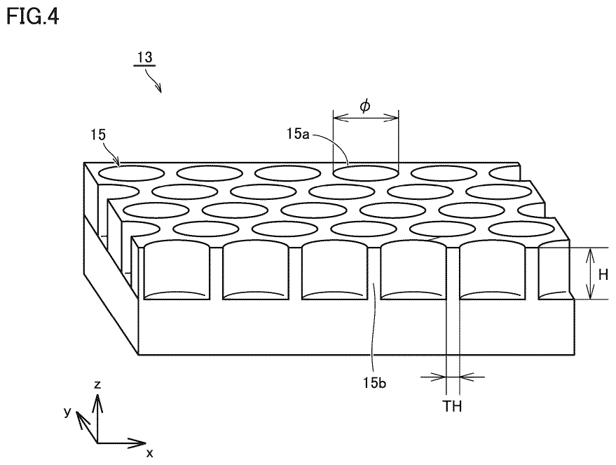

FIG. 4 is a perspective view showing an example of a configuration of collection substrate 13. Collection substrate 13 includes a plurality of pores 15. In this example, plurality of pores 15 are arrayed in a honeycomb shape. Each of plurality of pores 15 has a columnar shape. Each of pores 15 has a circular opening 15a and a depth extending in a direction including a vertically downward component. A partition wall 15b separates adjacent openings. An opening size is denoted by φ . A depth of pore 15 is denoted by H. A thickness of partition wall 15b (a thickness of the thinnest location) is denoted by TH.

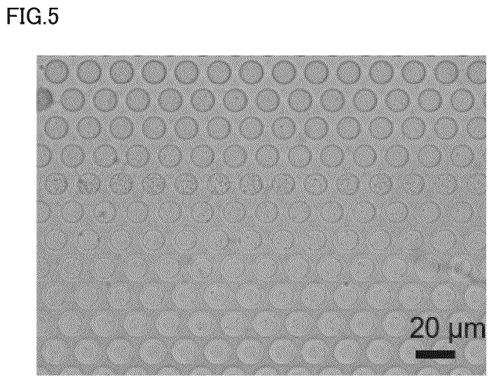

FIG. 5 is a view showing an optical observation image of collection substrate 13 actually produced. In the example shown in FIG. 5, opening size φ of pore 15 was 14 μm, depth H of pore 15 was 13 μm, and thickness TH of partition wall 15b was 4 μm.

However, plurality of pores 15 may be arrayed in any manner. Plurality of pores 15 may be arrayed linearly, may be arrayed in a matrix (in a gird), may be arrayed annularly, or may be arrayed concentrically, for example. In addition, each of pores 15 may have any shape. Each of pores 15 may have a bowl shape (spherical segment shape), may have a conical shape, may have a polygonal pyramid shape, or may have a rectangular parallelepiped shape, for example.

### Collection Mechanism

In the present embodiment, plurality of pores 15 are scanned with a laser beam to collect microorganisms in the sample into plurality of pores 15. This collection mechanism will be described in detail.

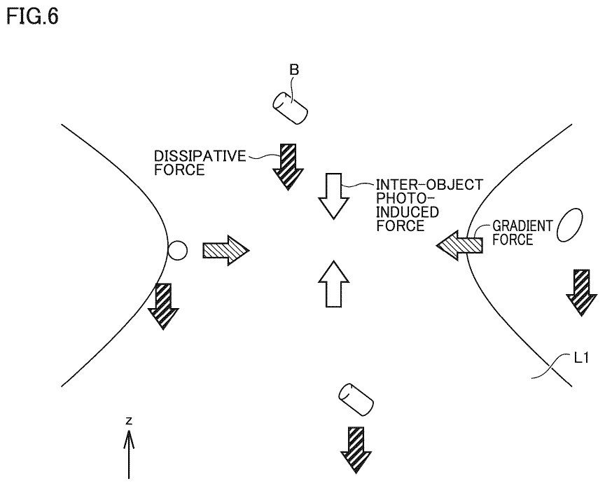

FIG. 6 is a conceptual diagram for describing the light-induced force generated by a laser beam. FIG. 6 shows a region of or in the vicinity of a beam waist of the laser beam in a magnified manner.

The light-induced force includes the inter-object photo-induced force, the gradient force, and the dissipative force. The dissipative force is noticeable in the light-induced force acting on microorganisms in a region away from the beam waist of the laser beam. A direction in which the dissipative force acts is the same as a direction of irradiation with the laser beam. Since plurality of pores 15 are irradiated with the laser beam downward from above in this example, the dissipative force acts on the microorganisms downward from above. Accordingly, the microorganisms move downward.

On the other hand, the inter-object photo-induced force and the gradient force are more noticeable than the dissipative force in the vicinity of the beam waist of the laser beam. In particular, the gradient force acts on the microorganisms strongly. Accordingly, the microorganisms are attracted to the beam waist.

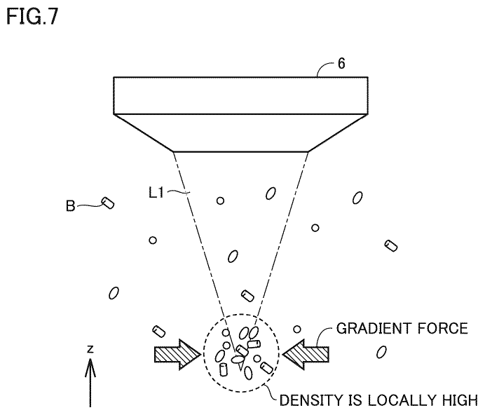

FIG. 7 is a conceptual diagram for describing a density distribution of microorganisms around the laser beam. The microorganisms initially located above the beam waist move to the vicinity of the beam waist by the dissipative force. The microorganisms are then attracted to the beam waist mainly by the gradient force. In addition, scanning with the laser beam causes the microorganisms located on a track of (and in the vicinity of) the beam waist to be also attracted to the beam waist by the gradient force. The microorganisms thus attracted to the vicinity of the beam waist stay in the vicinity of the beam waist. As a result, the density of the microorganisms is locally higher in the vicinity of the beam waist than in a region away from the beam waist. By scanning collection kit 1 with the laser beam in which the microorganisms have thus been attracted to the vicinity of the beam waist, the microorganisms are immediately collected in collection kit 1.

Note that the “vicinity” of the laser beam may be defined as described below. In a case in which the laser beam is a Gaussian beam, a distance in a radial direction from an optical axis of the laser beam at a cross section orthogonal to the optical axis is denoted by r, and a distance in the radial direction from the optical axis at which an amplitude is 1/e of an amplitude at the optical axis is denoted by r₀. While the amplitude has an absolute value proportionate to exp[−r²/r₀²], the laser beam has an optical electric field strength proportionate to the square of the absolute value of the amplitude, thus proportionate to exp[−2r²/r₀²]. Therefore, (an absolute value) of the gradient of the optical electric field strength becomes the largest at a position away from the beam waist by r₀/2, which is a position at which a second-order differential obtained by further differentiating a gradient (a first-order differential concerning r) of the optical electric field strength becomes zero. A range (r≤10r₀) in which the distance from the optical axis is on the same order as r₀ is preferably considered as the “vicinity” of the laser beam, and a range (r≤2r₀) in which the distance from the optical axis is within twice ro is more preferably considered as the “vicinity” of the laser beam.

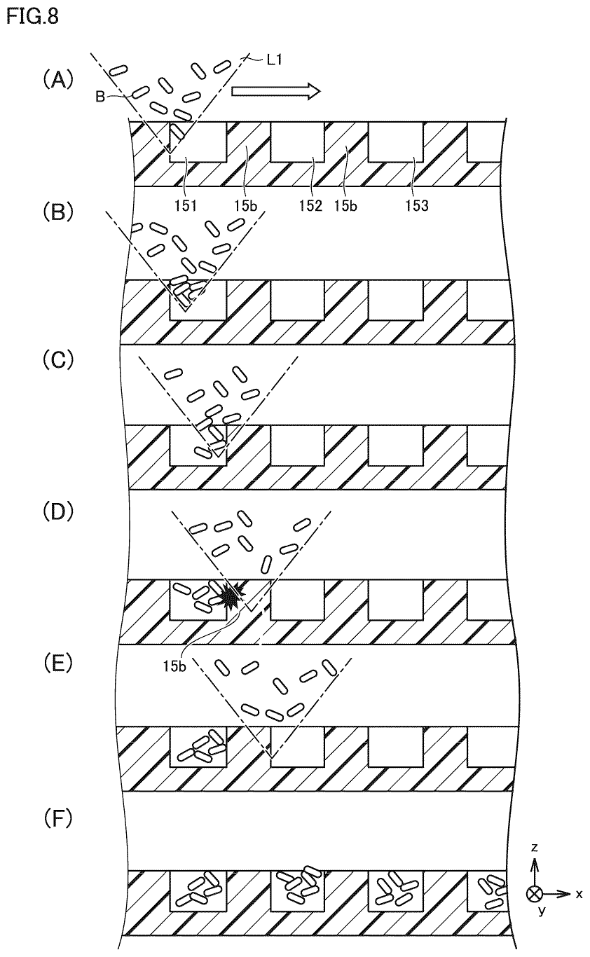

FIG. 8 is a conceptual diagram for describing how microorganisms are collected in association with scanning of collection kit 1 with a laser beam. It is desirable that the laser beam should be adjusted such that the beam waist is smaller than a size (opening size φ) of opening 15a of pore 15 and such that the beam waist is located on the inner side of each pore relative to opening 15a (below the upper surface of the partition wall). Description will be made using as an example a situation in which pores 15 are scanned with the laser beam from left to right (in the x-direction) in the drawing under the above conditions and in which the beam waist moves sequentially over a first pore 151, a second pore 152, and a third pore 153.

First, the beam waist is located at the left end of first pore 151 (see FIG. 8(A)). It is desirable to define a scanning speed of the beam waist such that each pore is irradiated with the laser beam for a time longer than a predetermined time. The predetermined time is a time required for microorganisms located outside a pore to move to the position of the beam waist by the dissipative force. Accordingly, in a case in which the beam waist is located inside first pore 151 (above the bottom surface of first pore 151), a situation is created in which the microorganisms are continually supplied to the beam waist.

While the beam waist is located inside first pore 151, the microorganisms above first pore 151 (and inside first pore 151) are gathered to the vicinity of the beam waist (see FIG. 8(B)). Thereafter, the beam waist continues moving to approach a right end of first pore 151 (see FIG. 8(C)). The microorganisms gathered to the vicinity of the beam waist then collide with partition wall 15b that separates first pore 151 and second pore 152 (see FIG. 8(D)). Then, movement of the microorganisms is interfered with partition wall 15b, while the beam waist continues moving to second pore 152. Accordingly, the gradient force strongly acting on the microorganisms in the vicinity of the beam waist is weakened quickly, so that the microorganisms drop inside first pore 151 (see FIG. 8(E)). As a result, the microorganisms are trapped and collected in each of first pore 151 to third pore 153 (see FIG. 8(F)).

Note that the “scanning of plurality of pores with the beam waist of the laser beam” can be achieved in any way so long as plurality of pores 151 (collection kit 1) can be scanned with the beam waist in a relative positional relationship. More specifically, the beam waist may be moved relative to fixed collection kit 1, or collection kit 1 may be moved relative to a fixed beam waist. Both the beam waist and collection kit 1 may be moved.

Although not illustrated, in a case in which the beam waist is located below the bottom surface of each pore, movement of the microorganisms is interfered with the bottom surface of each pore. Thus, strictly saying, the microorganisms are not able to reach the beam waist. Even so, the microorganisms are attracted to the vicinity of the beam waist, and the density of the microorganisms in the vicinity of the beam waist locally increases. Therefore, the effect of collection of the microorganisms by virtue of collision with the partition wall can be obtained. Thus, the beam waist may not necessarily be located inside the pore (above the bottom surface of the pore), and the beam waist may be located below the bottom surface of the pore.

### Collection Flow

FIG. 9 is a flowchart showing an example of a procedure of processing of collecting microorganisms. The processing shown in this flowchart is executed when a predetermined condition holds (e.g., when a user operates a start button of HMI 104). Respective steps are basically achieved by software processing by controller 10 (processor 101), but part or the whole of them may be achieved by hardware (an electric circuit) arranged in controller 10. It is assumed that a sample containing microorganisms to be collected (fluorescently stained microorganisms in the examples which will be described later) is prepared in advance.

In S101, controller 10 places collection kit 1 on XYZ-axis stage 2. This processing can be achieved by a mechanism (not illustrated) for feeding collection kit 1, for example. Instead of automatizing this processing, the user may manually place collection kit 1.

In S102, controller 10 introduces the sample into an inner side with respect to holding frame 12 of collection kit 1 and seals the introduced sample with cover glass 14. This processing may be automatized by a dispenser and a feed mechanism (neither illustrated), for example. The user may manually introduce the sample into collection kit 1 and place cover glass 14.

In S103, controller 10 sets the scanning speed and the scanning range of a beam waist. Controller 10 receives from HMI 104 a user operation that designates the scanning speed and the scanning range of the beam waist, for example.

Scanning with the beam waist may typically be performed linearly within a horizontal plane. However, the beam waist is not limited to a particular scanning pattern. Scanning with the beam waist may be performed in a matrix shape, for example. Scanning with the beam waist may be performed curvilinearly (e.g., annularly, conically, or spirally). Scanning with the beam waist may be performed within a plane inclined from the horizontal plane. The scanning speed of the beam waist is typically constant, but the scanning speed may be changed during scanning. Scanning with the beam waist is not limited to continuous one, but may be intermittent one. In other words, scanning with the beam waist may be performed so as to alternately repeat movement and stop.

In S104, controller 10 starts shooting an image of the sample in collection kit 1. More specifically, controller 10 controls illumination light source 8 so as to start irradiation of collection kit 1 with white light and controls camera 9 so as to shoot an image of collection kit 1 at a laser spot.

In S105, controller 10 adjusts the horizontal position of objective lens 6 using driver 7 such that the beam waist of the laser beam is located at an initial position of the scanning range set in S103 (in this example, however, the beam waist actually has not been formed because irradiation with the laser beam has not been started at this point of time). Controller 10 can extract collection substrate 13 from the image shot by camera 9, for example, to specify the initial position of the scanning range of the beam waist. Note that controller 10 may adjust the horizontal position of collection kit 1 using adjuster 3 instead of or in addition to the adjustment of the horizontal position of objective lens 6 using driver 7.

In S106, controller 10 adjusts the vertical height of objective lens 6 using driver 7 such that the beam waist of the laser beam is located inside each pore (below opening 15a of pore 15). The vertical position of the beam waist is known from specifications (in particular, a focal length) of objective lens 6. Therefore, controller 10 can set the position of the beam waist to be inside each pore based on geometrical properties of pore 15 (the vertical position of opening 15a and a depth of pore 15). Note that controller 10 may adjust a height of collection kit 1 using adjuster 3 instead of or in addition to the adjustment of the height of objective lens 6 using driver 7.

In S107, controller 10 controls laser light source 4 to start (or continue) irradiation of collection kit 1 with the laser beam and controls driver 7 to start (or continue) scanning with the beam waist. In response to scanning with the beam waist, a plurality of microorganisms are collected inside pores 15 in accordance with the collection mechanism described with reference to FIG. 6 to FIG. 8.

In S108, controller 10 determines whether or not scanning of the entire scanning range set in S103 with the beam waist has been completed. In a case in which scanning has not been completed (NO in S108), controller 10 returns the process to S107. Accordingly, irradiation with the laser beam and scanning with the beam waist are continued. When scanning with the beam waist is completed (YES in S108), controller 10 advances the process to S109.

In S109, controller 10 controls laser light source 4 to stop irradiation with the laser beam and controls driver 7 to stop scanning with the beam waist.

In S110, controller 10 terminates shooting an image of the sample in collection kit 1. Specifically, controller 10 controls illumination light source 8 to stop irradiation with white light and controls camera 9 such that the image shooting motion stops.

In S111, controller 10 analyzes the shot image of the sample (fluorescence images in the examples which will be described later). Controller 10 can calculate an area where the microorganisms are collected and calculate a survival rate of the collected microorganisms, for example. The series of processing is now terminated.

Note that shooting an image of the sample (processing in S104) is mainly intended for the image analysis and is not essential for collection of the microorganisms. Therefore, shooting an image of the sample and the image analysis (processing in S111) may be omitted. Alternatively, an image of the sample may be shot after irradiation with the laser beam and scanning with the beam waist are stopped (after processing in S109), rather than shooting an image of the sample during irradiation with the laser beam and scanning with the beam waist.

The adjustment of the horizontal position of objective lens 6 (processing in S105) and the adjustment of the vertical height of objective lens 6 (processing in S106) may be reversed in order. In this case, in a case in which similar collection processing is repeated for a plurality of collection kits 1, for example, the adjustment of the height of objective lens 6 may be carried out only at a first time and may be omitted at second and subsequent times.

### Verification Result

The inventors of the present invention verified whether the time required to collect microscopic objects was able to be reduced by the collection mechanism which combined scanning with the beam waist and partition wall 15b of pore 15. A result of verification will be described in comparison with comparative examples in which a position to be irradiated with the laser beam is fixed.

In any of the comparative examples and examples, fluorescently stained bacteria were collected. SYTO9 (registered trademark) or propidium iodide (PI) was used as a fluorescent dye. SYTO9 stains both living bacteria and killed bacteria and emits green fluorescence. On the other hand, PI stains only killed bacteria and emits red fluorescence. Fluorescence observation images obtained at an excitation wavelength for SYTO9 are denoted by “SYTO9 images.” Fluorescence observation images obtained at an excitation wavelength for PI are denoted by “Pl images.”

### Comparative Example 1

In Comparative Example 1, fluorescence observation images in a case in which a sample was not scanned with the beam waist were acquired. A sample containing three types of bacteria, specifically, a sample containing Lactobacillus casei, Pseudomonas aeruginosa, and Staphylococcus aureus, was used. The irradiation time of the laser beam (hereinafter referred to as a “light irradiation time”) was set to fall within a range from 15 minutes to 90 minutes at a 15-min interval. A spot size of the laser beam (a diameter of the laser beam on collection kit 1) was set at 107.6 μm. Laser output was set at 800 mW. A density of each type of bacteria was 1.0×10⁸ [CFU/mL]. That is, a sum density of the three types of bacteria was 3.0×10⁸ [CFU/mL].

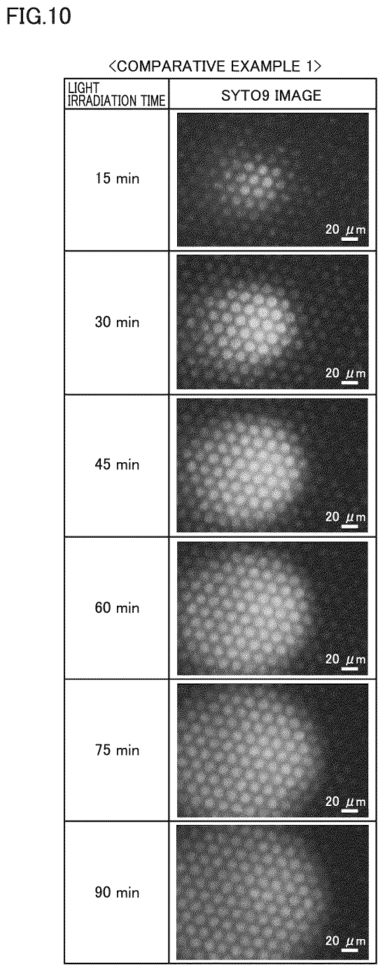

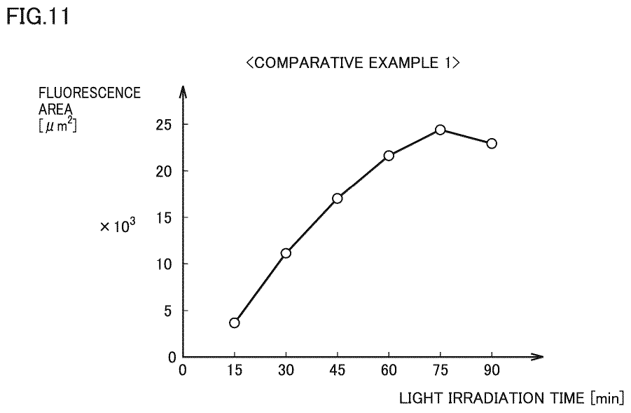

FIG. 10 shows SYTO9 images showing a collection result of bacteria (both living bacteria and killed bacteria) in Comparative Example 1. FIG. 11 is a diagram showing light irradiation time dependency of the result of collection of bacteria in Comparative Example 1. The horizontal axis represents the light irradiation time. The vertical axis represents the fluorescence area (i.e., an area where the overall bacteria were collected). In this example, when the light irradiation time ranged from 15 minutes to 75 minutes, the fluorescence area increased as the light irradiation time was longer. When the light irradiation time reached 75 minutes, the fluorescence area was saturated. FIG. 10 and FIG. 11 reveal that the light irradiation time required to collect a certain amount of bacteria without being scanned with the beam waist was on the minute order (in particular, a two-digit minute order of approximately ten and several minutes to several ten minutes).

### Example 1

In Example 1, a sample only containing Lactobacillus casei was used. The beam waist of the laser beam was set at 2.5 μm. Laser output was set at 800 mW. The density of Lactobacillus casei was 10⁸ [CFU/mL]. The scanning speed of the laser beam was set at 1 [μm/s]. At this scanning speed, the light irradiation time per pore was about 14 seconds.

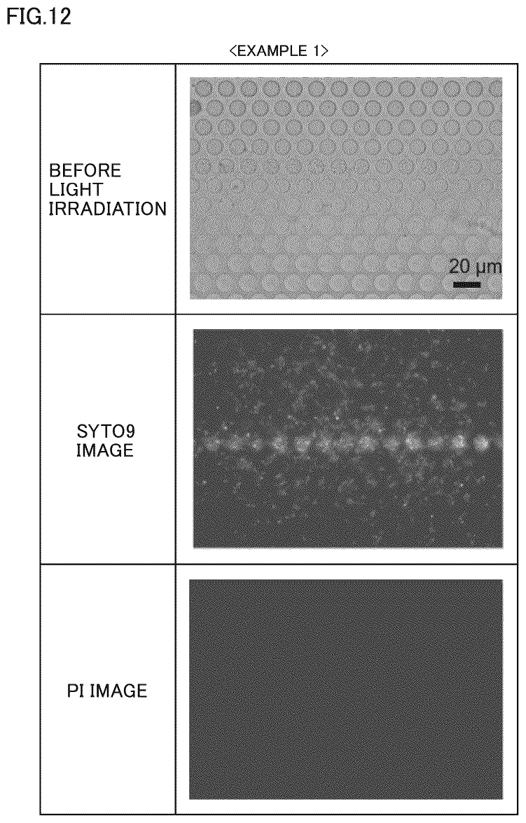

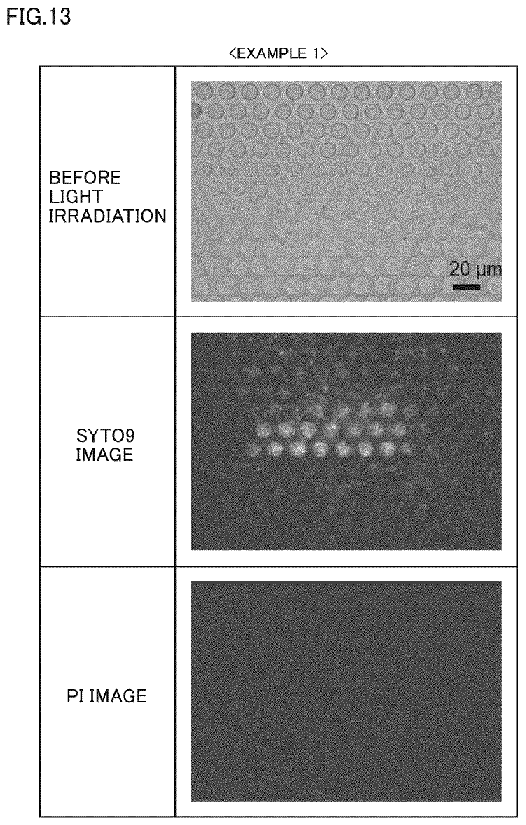

FIG. 12 is a view showing a first example of a collection result of Lactobacillus casei in Example 1. FIG. 13 is a view showing a second example of the collection result of Lactobacillus casei in Example 1. An optical observation image of collection substrate 13 is shown at the top, a SYTO9 image is shown at the middle, and a PI image is shown at the bottom.

As a result of one-dimensional scanning with the beam waist, Lactobacillus casei was collected in pores 15 laid out horizontally in a line as shown in FIG. 12. As a result of two-dimensional scanning with the beam waist, Lactobacillus casei was collected in a matrix shape of approximately three columns in length and seven rows in width as shown in FIG. 13. This reveals that the time required to collect Lactobacillus casei in each of pores 15 is only on the second order and also reveals that most of Lactobacillus casei was collected in a living state as compared to the PI image.

### Example 2

In Example 2, a sample only containing Pseudomonas aeruginosa was used. The beam waist of the laser beam was set at 2.5 μm. Laser output was set at 800 mW. The density of Pseudomonas aeruginosa was 10⁸ [CFU/mL]. The scanning speed of the laser beam was set at 2 [μm/s], that is, twice the scanning speed of the laser beam in Example 1. At this scanning speed, the light irradiation time per pore was about seven seconds.

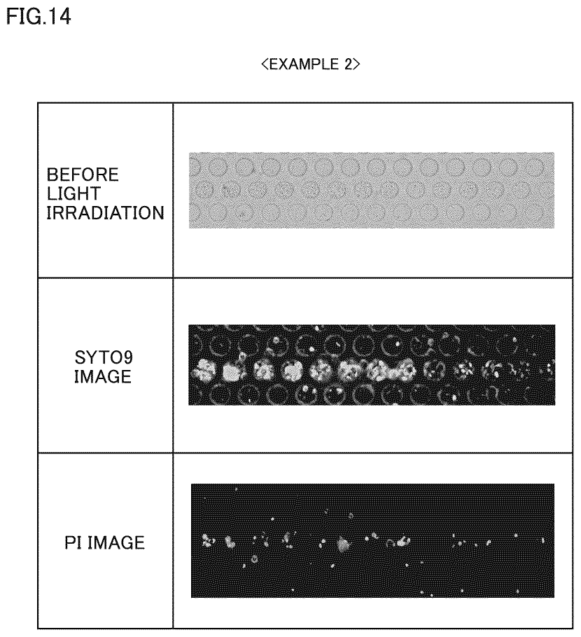

FIG. 14 is a view showing a collection result of Pseudomonas aeruginosa in Example 2. As a result of one-dimensional scanning with the beam waist, Pseudomonas aeruginosa was collected in pores 15 laid out horizontally in a line even at the double scanning speed. The time required to collect Pseudomonas aeruginosa in each of pores 15 was only on the second order (in particular, a single-digit second order of approximately several seconds). Most of Pseudomonas aeruginosa was collected in the living state.

As shown in Examples 1 and 2, the scanning speed of the beam waist is preferably determined such that the light irradiation time for each of plurality of pores 15 is on the second order. Depending on a collection target, the light irradiation time per pore can also be determined to be on the single-digit second order. The scanning speed of the beam waist is preferably determined at a speed faster than a speed at which each of plurality of pores 15 is filled with a plurality of microorganisms. This is because microorganisms can be collected more efficiently (the number of microorganisms collected per unit time is larger) from the perspective of all the plurality of pores than in a case of setting the scanning speed of the beam waist at such a slow speed at which each pore is filled.

In order to collect an approximately certain amount of bacteria, it is required to scan many pores 15 with the beam waist. In Comparative Example 1 shown in FIG. 10, at least 15 minutes (=900 seconds) were required to fill about 40 pores. On the other hand, according to Examples 1 and 2, even in a case in which the same number of pores were scanned with the beam waist, the required time was only 40×14 seconds=approximately 560 seconds (in the case of Lactobacillus casei) or 40×7 seconds=approximately 280 seconds (in the case of Pseudomonas aeruginosa), that is, the required time was on the single-digit minute order. This reveals that the present examples were able to significantly reduce the time required to collect bacteria (specifically to a fraction or even by approximately one digit in some cases) as compared with Comparative Example 1.

### Comparative Example 2

In Comparative Example 2, fluorescence observation images in a case in which a sample was let to stand without being irradiated with the laser beam were acquired. Similarly to Comparative Example 1, a sample containing Lactobacillus casei, Pseudomonas aeruginosa, and Staphylococcus aureus was used. The density of each type of bacteria was 1.0×10⁹ [CFU/mL]. That is, a sum density of the three types of bacteria was 3.0×10⁹ [CFU/mL]. A standing time was set at three minutes.

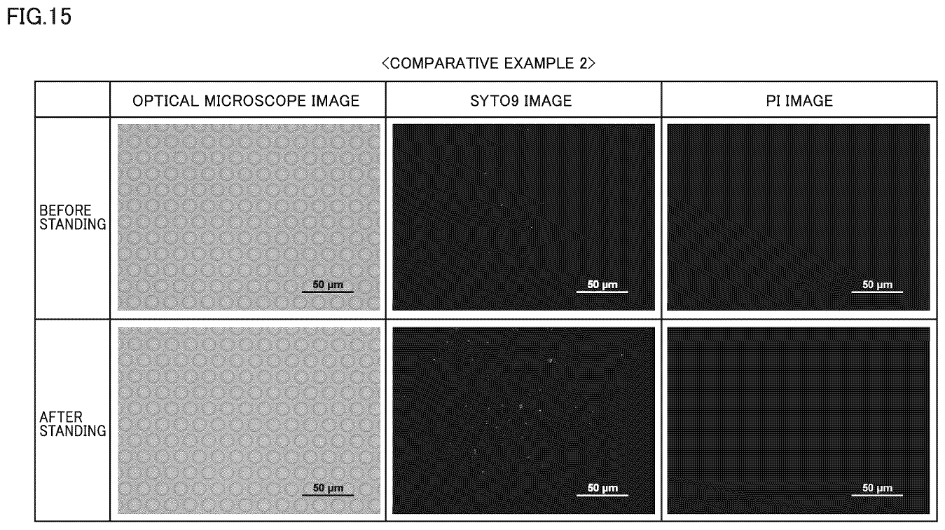

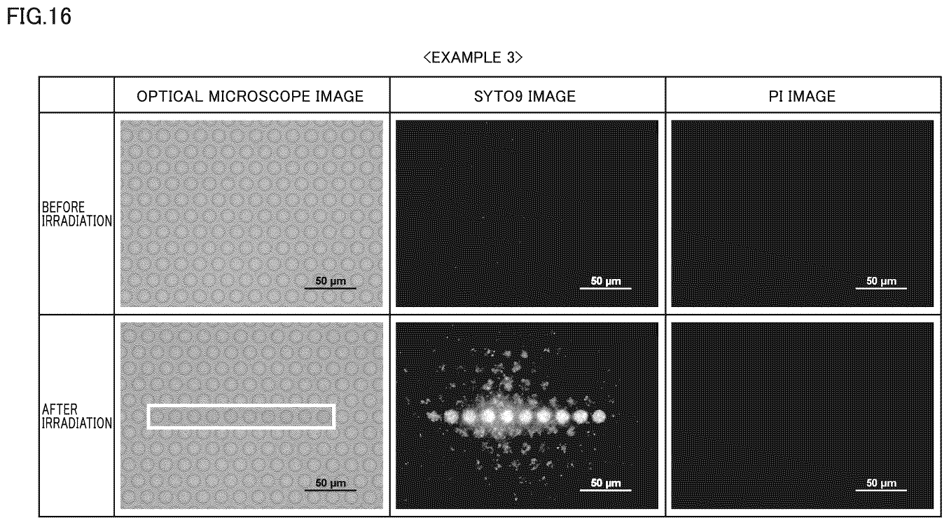

FIG. 15 is a view showing a collection result of the three types of bacteria in Comparative Example 2. Optical observation images of collection substrate 13 are shown at the left, SYTO9 images are shown at the middle, and PI images are shown at the right. The same applies to subsequent FIG. 16. Respective images before standing are shown at the top, and respective images after standing are shown at the bottom. FIG. 15 reveals that bacteria were not collected only by letting the sample to stand without irradiation with the laser beam.

### Example 3

In Example 3, fluorescence observation images in a case in which a sample was scanned with the beam waist of the laser beam were acquired. The sample used in Example 3 was the same as that used in Comparative Example 2. Laser output was set at 800 mW. The scanning speed of the beam waist was set at 1 [μm/s]. The scanning distance of the beam waist was a distance (less than 2 mm) equivalent to about ten pores.

FIG. 16 is a view showing a collection result of the three types of bacteria in Example 3. Respective images before irradiation with the laser beam are shown at the top, and respective images after irradiation with the laser beam are shown at the bottom. FIG. 16 reveals that the three types of bacteria were collected in the living state in regions irradiated with the laser beam. A survival rate of the three types of bacteria was calculated to be 99.40% by comparison between the SYTO9 images and PI images. This reveals that the bacteria were hardly damaged by the irradiation with the laser beam.

### Selective Collection

The collection kit may be configured to be capable of selectively detecting particular microorganisms in a case in which a sample contains a plurality of types of microorganisms.

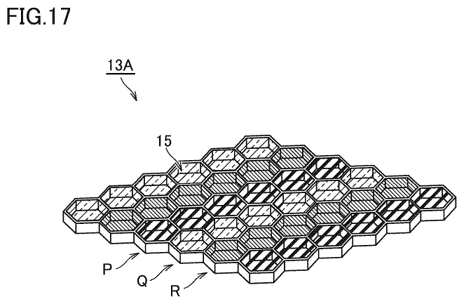

FIG. 17 is a diagram showing a configuration of an example of a collection kit for selectively collecting microorganisms. FIG. 17 only shows a collection substrate 13A included in the collection kit. In collection substrate 13A, plurality of pores 15 are distinguished per line. Pores 15 laid out in the same line are modified with the same type of host substance (such as an antibody or a protein). On the other hand, host substances differ in type between adjacent lines. More specifically, a line P is modified with a host substance to be specifically bound to a first type of microorganisms. A line Q is modified with a host substance to be specifically bound to a second type of microorganisms. A line R is modified with a host substance to be specifically bound to a third type of microorganisms. FIG. 17 expresses the difference in type of host substance by the difference in hatching.

For example, by scanning line P with the beam waist (see FIG. 12) and then cleaning a surface of collection substrate 13A, the first type of microorganisms among the first to third types of microorganisms can be selectively collected in line P. Alternatively, by scanning each of line P, line Q, and line R with the beam waist (see FIG. 13) and then cleaning the surface of collection substrate 13A, the first type of microorganisms can be selectively collected in line P, the second type of microorganisms can be selectively collected in line Q, and the third type of microorganisms can be selectively collected in line R.

Note that FIG. 17 illustrates a configuration in which plurality of pores 15, each being modified with the same type of host substance, are laid out in a line (linearly). However, plurality of pores 15 may be laid out in any pattern. Plurality of pores 15 may be laid out curvilinearly or two-dimensionally, for example.

As described above, the present embodiment combines a control feature of scanning with the beam waist that attracts microorganisms mainly using the gradient force and a structural feature of partition wall 15b provided for collection kit 1 to achieve a mechanism that rapidly collects a plurality of microorganisms. Thus, the present embodiment can reduce the time required to collect a plurality of microorganisms contained in a liquid sample.

### Large-Area Collection

In this example, a laser beam emitted from an optical fiber was used without being focused by the objective lens. Since the laser beam was not focused, it is considered that the dissipative force was dominant in the light-induced force acting on microscopic objects and that the gradient force hardly acted on the microscopic objects. In addition, a photothermal conversion material (such as a metal thin film) was not provided at a tip of the optical fiber. Thus, a photothermal effect of converting the laser beam into heat by the tip of the optical fiber did not occur. That is, the use of the optical fiber enabled the dissipative force to selectively act on the microscopic objects without causing the photothermal effect and while avoiding the action of the gradient force.

Fluorescence observation images in a case in which the laser beam (beam spot) was large and in which the scanning speed of the beam spot was high were acquired. Specifically, a sample containing fluorescent beads as pseudo bacteria was used. The density of the fluorescent beads was 5.68×10⁸ [particles/mL]. A spot size of the laser beam was set at about 200 μm (about twice that of Comparative Example 1). The scanning distance of the beam spot was set at 5 mm. Laser output was set at 750 mW. The scanning speed of the beam spot was set at 16.7 [μm/s] (=about 1 [mm/min]). This scanning speed is faster than the scanning speed (1 [μm/s]) in Example 3 by a factor as large as about 17.

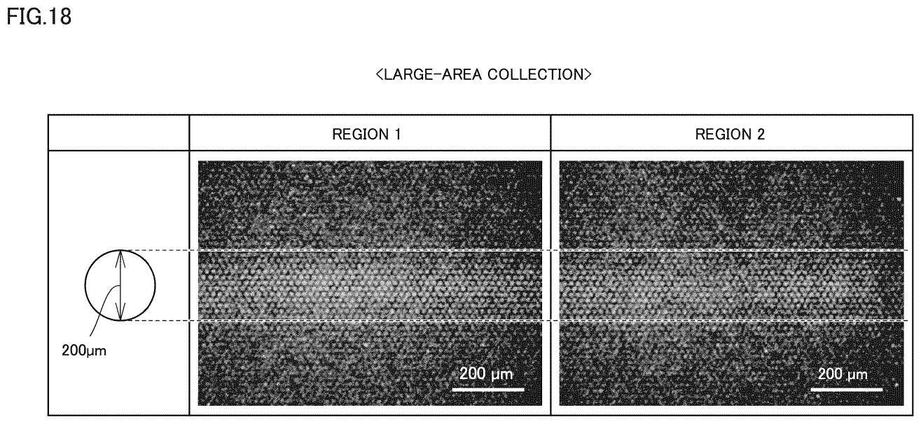

FIG. 18 is a view showing a collection result of fluorescent beads in a case in which the objective lens was not used. FIG. 18 shows a collection result of fluorescent beads in each region in a case in which regions 1 and 2 were linearly scanned with a beam spot. FIG. 18 reveals that the fluorescent beads were able to be collected even when the area irradiated with the laser beam was large and when the scanning speed of the beam spot was high. However, the collection density of the fluorescent beads was lower than the collection density of the three types of bacteria in Example 3.

In the case in which the laser beam is focused by the objective lens, the area where microscopic objects are collected is relatively small, as the spot size of the laser beam is small. On the other hand, the microscopic objects can be collected at a high density, as the gradient force acts on the microscopic objects in addition to the dissipative force.

In contrast, in the case in which the laser beam is not focused by the objective lens, the collection density of the microscopic objects may be relatively small, as the gradient force hardly acts on the microscopic objects. However, the microscopic objects can be collected across a large area, as the spot size of the laser beam is large. In addition, the scanning speed of the beam spot can also be set at a high speed as shown in FIG. 18, thus enabling collection to be achieved in a large area and in a short time.

### Clauses

In the last place, various aspects of the present disclosure will be described as clauses together.

### Clause 1

A microscopic object collection method for collecting a plurality of microscopic objects contained in a liquid sample, the microscopic object collection method including:
preparing a substrate including a plurality of pores each having a partition wall that separates adjacent ones of openings;
introducing the liquid sample onto the substrate; and
irradiating the plurality of pores with a laser beam focused by a lens, in which
the irradiating includes scanning the plurality of pores with a beam waist of the laser beam.

### Clause 2

The microscopic object collection method according to clause 1, in which the scanning includes causing the plurality of microscopic objects attracted to a position of the beam waist by a gradient force of the laser beam to collide with the partition wall to fall down by scanning the beam waist.

### Clause 3

The microscopic object collection method according to clause 1 or 2, in which the scanning includes scanning the beam waist under a condition adjusted such that the beam waist is smaller than a size of the openings and such that the beam waist is located inside each of the plurality of pores relative to each of the openings.

### Clause 4

The microscopic object collection method according to any one of clauses 1 to 3, in which
the scanning speed of the beam waist is determined such that each of the plurality of pores is irradiated with the laser beam for a time longer than a predetermined time, and
the predetermined time is a time required for at least one microscopic object among the plurality of microscopic objects, the at least one microscopic object being located outside the plurality of pores, to move to a position of the beam waist by a dissipative force of the laser beam.

### Clause 5

The microscopic object collection method according to any one of clauses 1 to 4, in which the scanning speed of the beam waist is determined such that a time during which each of the plurality of pores is irradiated with the laser beam is on a second order.

### Clause 6

The microscopic object collection method according to clause 5, in which the scanning speed of the beam waist is determined such that the time during which each of the plurality of pores is irradiated with the laser beam is on a single-digit second order.

### Clause 7

The microscopic object collection method according to any one of clauses 1 to 6, in which the scanning speed of the beam waist is determined at a speed higher than a speed at which each of the plurality of pores is filled with the plurality of microscopic objects.

### Clause 8

The microscopic object collection method according to any one of clauses 1 to 7, in which a region to be irradiated with the laser beam in the plurality of pores does not contain a photothermal conversion material that converts the laser beam into heat.

### Clause 9

The microscopic object collection method according to any one of clauses 1 to 8, in which the laser beam has a wavelength outside a wavelength range of electronic resonance of the plurality of microscopic objects.

### Clause 10

The microscopic object collection method according to any one of clauses 1 to 9, in which
the plurality of microscopic objects include a plurality of types of microscopic objects, and
each of the plurality of pores is modified with a host substance to be specifically bound to a corresponding type of microscopic objects among the plurality of types of microscopic objects.

### Clause 11

A microscopic object collection method for collecting a plurality of microscopic objects contained in a liquid sample, the microscopic object collection method including:
preparing a substrate including a plurality of pores, each having a partition wall that separates adjacent ones of openings;
introducing the liquid sample onto the substrate; and
irradiating the plurality of pores with a laser beam without being focused by a lens, in which
the irradiating includes scanning the plurality of pores with the laser beam.

### Clause 12

The microscopic object collection method according to clause 11, in which the irradiating includes irradiating the plurality of pores with the laser beam through an optical fiber to cause a dissipative force of the laser beam to selectively act on the plurality of microscopic objects, the optical fiber including no photothermal conversion material at a tip.

### Clause 13

A microscopic object collection system for collecting a plurality of microscopic objects contained in a liquid sample, the microscopic object collection system including:
a holder configured to hold a substrate including a plurality of pores, each having a partition wall that separates adjacent ones of openings;
a light source configured to emit a laser beam;
a lens configured to focus the laser beam to generate a beam waist;
a driver configured to change a position of the beam waist relative to the plurality of pores; and
a controller configured to control the driver such that the plurality of pores are scanned with the beam waist.

It should be understood that the embodiments disclosed herein are illustrative and non-restrictive in every respect. The scope of the present disclosure is defined by the claims, not by the description of the above-described embodiments, and is intended to include any modification within the meaning and scope equivalent to the claims.

1. A microscopic object collection method for collecting a plurality of microscopic objects contained in a liquid sample, the microscopic object collection method comprising:
preparing a substrate including a plurality of pores each having a partition wall that separates adjacent ones of openings;
introducing the liquid sample onto the substrate; and
irradiating the plurality of pores with a laser beam focused by a lens, wherein
the irradiating includes scanning the plurality of pores with a beam waist of the laser beam.

2. The microscopic object collection method according to claim 1, wherein the scanning includes causing the plurality of microscopic objects attracted to a position of the beam waist by a gradient force of the laser beam to collide with the partition wall to fall down by scanning the beam waist.

3. The microscopic object collection method according to claim 2, wherein the scanning includes scanning the beam waist under a condition adjusted such that the beam waist is smaller than a size of the openings and such that the beam waist is located inside each of the plurality of pores relative to each of the openings.

4. The microscopic object collection method according to claim 1, wherein
the scanning speed of the beam waist is determined such that each of the plurality of pores is irradiated with the laser beam for a time longer than a predetermined time, and
the predetermined time is a time required for at least one microscopic object among the plurality of microscopic objects, the at least one microscopic object being located outside the plurality of pores, to move to a position of the beam waist by a dissipative force of the laser beam.

5. The microscopic object collection method according to claim 1, wherein the scanning speed of the beam waist is determined such that a time during which each of the plurality of pores is irradiated with the laser beam is on a second order.

6. The microscopic object collection method according to claim 5, wherein the scanning speed of the beam waist is determined such that the time during which each of the plurality of pores is irradiated with the laser beam is on a single-digit second order.

7. The microscopic object collection method according to claim 1, wherein the scanning speed of the beam waist is determined at a speed higher than a speed at which each of the plurality of pores is filled with the plurality of microscopic objects.

8. The microscopic object collection method according to claim 1, wherein a region to be irradiated with the laser beam in the plurality of pores does not contain a photothermal conversion material that converts the laser beam into heat.

9. The microscopic object collection method according to any claim 1, wherein the laser beam has a wavelength outside a wavelength range of electronic resonance of the plurality of microscopic objects.

10. The microscopic object collection method according to claim 1, wherein
the plurality of microscopic objects include a plurality of types of microscopic objects, and
each of the plurality of pores is modified with a host substance to be specifically bound to a corresponding type of microscopic objects among the plurality of types of microscopic objects.

11. A microscopic object collection method for collecting a plurality of microscopic objects contained in a liquid sample, the microscopic object collection method comprising:
preparing a substrate including a plurality of pores each having a partition wall that separates adjacent ones of openings;
introducing the liquid sample onto the substrate; and
irradiating the plurality of pores with a laser beam without being focused by a lens, wherein
the irradiating includes scanning the plurality of pores with the laser beam.

12. The microscopic object collection method according to claim 11, wherein the irradiating includes irradiating the plurality of pores with the laser beam through an optical fiber to cause a dissipative force of the laser beam to selectively act on the plurality of microscopic objects, the optical fiber including no photothermal conversion material at a tip.

13. A microscopic object collection system for collecting a plurality of microscopic objects contained in a liquid sample, the microscopic object collection system comprising:
a holder configured to hold a substrate including a plurality of pores each having a partition wall that separates adjacent ones of openings;
a light source configured to emit a laser beam;
a lens configured to focus the laser beam to generate a beam waist;
a driver configured to change a position of the beam waist relative to the plurality of pores; and
a controller configured to control the driver such that the plurality of pores are scanned with the beam waist.
